(19) United States
(12) Patent Application Publication
(10) Pub. No.: US 2015/0366745 A1
(43) Pub. Date: Dec. 24, 2015

(54) LONGEUER METHOD TO ACHIEVE BODY ALIGNMENT

(71) Applicant: REVEL*AGING, LLC, Edwards, CO (US)

(72) Inventors: Al BEEDIE, Edwards, CO (US); Darce O'CONNOR, Eagle, CO (US); Eric ECKDAHL, Eagle, CO (US)

(21) Appl. No.: 14/414,398

(22) PCT Filed: Jul. 11, 2013
(86) PCT No.: PCT/US2013/050025

§ 371 Date: Jan. 12, 2015

Related U.S. Application Data
(60) Provisional application No. 61/671,450, filed on Jul. 13, 2012.

(51) Int. Cl. A61H 7/00

(52) U.S. Cl. CPC A61H 7/003; A61H 2201/1253; A61H 2205/081; A61H 2205/04

(57) ABSTRACT

The present invention provides methods of improving an individual's body (including spinal alignment), which can lead to an improved overall fitness level, including improved flexibility, length of muscle, range of motion, and/or suppleness.

This application claims priority to U.S. provisional application, 61/671,450 filed on Jul. 13, 2012.

### FIELD OF THE INVENTION

The invention relates to a technique that achieves body alignment.

### BACKGROUND OF THE INVENTION

Back pain is a very common health problem worldwide and is a major cause for work-related disability benefits and compensation. Back pain may arise from spinal misalignment, strained muscles, ligaments, or tendons in the back and/or structural problems with bones or spinal discs. The back pain may be acute or chronic. Treatments for chronic back pain vary widely and include physical therapy and exercise, chiropractic treatments, rest, pharmacological therapy such as pain relievers or anti-inflammatory medications, and surgical intervention such as vertebral fusion, discectomy or disc repair, etc. Existing treatments can be costly, addictive, temporary, ineffective, and/or can increase the pain or require long recovery times.

Many people have serious back disorders due to a lack of physical conditioning. Back disorders are caused by one or a combination of poor posture, use of improper body mechanics, stress, lack of proper exercise, poor health, etc. With proper exercise and conditioning, the risk of back injury can be reduced, if not eliminated altogether, by gradually stretching and positioning of the spine to relieve pain and realign the individual vertebrae. Effective exercise provides increased endurance and eliminates muscular problems and range of motion problems.

Proper posture can be affected through passive, active, and resistive exercise. Although the prior art contains many examples of equipment for providing cervical traction to the head and neck, there is no single apparatus which provides all of the recommended exercises to improve posture.

The human spine is divided functionally into six units, the skull, the cervical region (C1 to C4), the thoracic region (C5 to T7), the lower thoracic region (T8 to L2), the lumbar region, (L1 to L5), and the sacral region (S1 to S5, which are fused together). The neck, or cervical spine, has seven vertebrae that assume a natural anterior convex curvature, known as lordosis.

With correct lateral spine posture, there is forward lordotic curve in the cervical region, a backward kyphotic curve in the thoracic region, and a forward lordotic curve in the lumbar region. An abnormal posture with an exaggerated backward curvature of the spine in any region is called kyphosis and resembles a hunch-back posture. A third abnormal posture, scoliosis, is evidenced by an S-shaped curvature of the spine when viewed from the back.

The spine may be divided further into single functional units that consist of a single vertebrae and the disc that separates them. The anterior portion of the vertebral functional unit is the weight bearing portion, and it is ideally constructed with two rounded vertebrae with flattened ends. These vertebrae are separated by an invertebral disc that acts as a spacer and shock absorber.

A natural alignment or neutral spine is characterized as a mid-way point between maximum anterior pelvic tilt and a maximum posterior pelvic tilt. This should be a comfortable position with the shoulders held back and relaxed and the head situated straight ahead with the hard palate parallel to the floor. If a plumb line were dropped from the center point of the head to the floor, this line would go through specific points of spinal joints at each level. More specifically, with normal lordosis, the line would pass through the anterior third of the C4/C5 disc, and back of the center of the body of the L-3 vertebrae. For the best function and durability of the spine, it is important to maintain proper lordosis in an effort to allow weight bearing to be done by the parts of the spine that are designed to handle it.

Normal alignment, curvature, and pelvic angle are important to minimize back and other joint problems. When injuries occur, the neck and other joints can assume an altered position and posture, sometimes referred to as subluxation. This condition results when there is an incomplete dislocation of a joint. Although a relationship between the joint members is altered, contact between joints surfaces remain. When neutral alignment is not maintained, there is an increase in the likelihood of injury, promotion of wear and tear of the joints, and a slowing down of the recoverability. Hence, proper posture and alignment and full range of motion are mandatory for normal spinal and joint integrity.

Loss of neutral alignment can result in a number of maladies, including loss of the ability of the skull to forward flex on the atlas, which produces a forward head posture. Forward head posture generally causes a loss of the cervical lordotic curve. Weakened or injured muscles and ligaments can result in a high shoulder which is commonly associated with a lateral acute angle deviation to the high shoulder side that forms the lower cervical and upper dorsal spine (C-D) angle on that side. An associated subluxation is forward protruding hip posture.

In addition, when there is a loss of alignment, the subluxations can “pinch” the nerve or impede the proper flow of nerve signals to the muscles, which can lead to muscle weakness. The nerves are not able to transmit the necessary signals for proper functioning to the muscle. Further, if there is a severe impedance of nerve signals, this can cause the muscle to contract or shorten, which can over time become “permanent”. This muscle contraction or shortening also can cause the corresponding tendons to shorten. All of these can lead to tightness and pain, as well is suboptimal muscle performance. In addition, when there is a loss of alignment, the body tends to compensate to try and pull things back into alignment, thus further leading to muscle imbalance and muscle weakness and pain, and joints such as the hip and knees wearing out, etc.

To address back pain, a huge multi-billion dollar, multi-faceted industry has developed, including the use of prescription and over the counter medicines, heat/cool wraps or patches, specialized mattresses, pillows, chiropractic care, acupuncture, surgery, massage and specialized exercise systems such as Yoga and Pilates. This also applies to joint pain such as the hips and knees. There, however, remains a need for a system that can lead to proper body, including spinal, alignment that is effective, inexpensive and does not require the use of medicines or specialized machinery or gadgets. The present invention meets this need.

### SUMMARY OF THE INVENTION

The present invention provides methods of improving an individual's body, including spinal alignment, which can then lead to overall fitness, including improved flexibility, length of muscle, range of motion, and suppleness. Methods of the present invention involve shortening and relaxing the individual's muscles and tendons; and applying pressure to the shortened and relaxed muscles and tendons, thru rubbing. The rubbing needs to range from very easy to moderate. The method may further comprise having the individual perform exercise after the shortening and relaxing the individual's muscles and tendons; and applying rubbing. Exercises such as “Cats and Dogs,” spinal twist, side bends, circling the legs forward and back, raising the legs allow the person's body to gradually achieve a new range of movement. In some embodiments, only one part of the body is addressed and in other embodiments more than one part of the body is addressed. In certain embodiments, the entire body is addressed.

The muscles and tendons can be shortened or relaxed by the individual themselves, (except for the back which requires assistance by another person) or another person could assist in the movement of the body part to achieve the shortening of the muscles and tendons and then rubbing.

### DETAILED DESCRIPTION OF THE INVENTION

The methods and procedures described herein relate to techniques for improving an individual's body alignment. Improving means that the body is more aligned than what the body was before starting the program and includes achieving what is considered the optimal alignment For example, by improving an individual's body alignment (which includes spinal alignment), flexibility, posture, suppleness, and range of motion can also improve. In general, the techniques include steps for shortening and relaxing an individual's muscles and tendons and rubbing, or in some instances applying a slight to moderate pressure through rubbing, to the shortened, relaxed muscles and/or tendons. The inventors have discovered that by using the regimen of shortening and relaxing a muscle (so it is not contracted) and then rubbing, and in some instances applying a slight (just barely feel the pressure) to moderate amount of pressure (substantially before there is pain), this causes the muscle to release and relax, causes muscle tension/knots to be released, and thus allows the muscle to return to a normal, healthy elongated state. This in turn relieves pressure on the surrounding tendons, so they also can return to the normal elongated state. In addition, the tendons are also rubbed when in a shortened and relaxed state. The inventors discovered that rubbing the tendons when in a shortened and relaxed state causes them to release and lengthen also. By allowing the muscles and tendons to achieve a normal, healthy elongated state, they will pull less inappropriately on the various body parts and thus will allow the body, including spine, to return to a normal-healthy alignment. The inventors found that conventional stretching and exercise techniques and typical massage techniques simply do not allow the muscle/tendons to release and elongate to the state they should be in for a normal, healthy alignment/condition. Stretching stresses the muscles and causes the muscles and body to resist. Stress releases adrenaline and cortisol, which causes the body to be further stressed and inflamed, which further requires recovery from the stretching process. Regarding massage techniques, this is performed usually on a person lying prone on a table (and in some cases, a limb is raised by the therapist). In this position the muscles and tendons are not in a shortened and relaxed state but are in a lengthened and stretched state.

Once the muscles and tendons are in the appropriate elongated state, and the body and spine are in alignment, the flow of nerve energy is returned to normal. The muscles can then better react to exercise stimulus and become toned. Further, the body becomes more flexible and supple as the muscles and tendons become elongated and alignment returns to areas of the spine, hips, knees, etc.

In certain embodiments, the techniques may also include additional movements and non-strenuous exercises (such as walking, and movements such as “Cats and Dogs,” spinal twist, side bends, circling the legs forward and back, and raising the legs). For example, these additional movements may be performed after certain muscles and tendons have undergone the techniques described herein.

In one embodiment, the additional movements may be performed after an individual has undergone the techniques described herein on the majority or entirety of the body. In other embodiments, a certain section of the body undergoes the treatment and that section of the body is then exercised. In other instances, the additional movements may be performed in between working on muscles and tendons in specific areas of the body. For example, if an individual has cramping or tightness in a specific body area, they can perform methods of the present invention (the Longeuer method) for the area.

In certain embodiments, the muscles and tendons are shortened and relaxed by moving the body part (such as for example, flexing the arm up to shorten the bicep) or by another person moving a body part (for example, a forearm) such that the muscles and tendons become shortened and then relaxed. The present invention requires the individual to relax their muscles and tendons. In this situation, an individual may shorten first and then relax the necessary muscles and tendons themselves or have someone facilitate the shortening and relaxation. As noted, the rubbing may be applied with an individual's hands or with another object such as a massage tool. In a preferred embodiment, the rubbing is performed by an individual's hands. Of course, the pressure may be applied in any manner known to those of skill in the art. The amount of pressure applied with the rubbing may vary. For example, in one embodiment, the amount of pressure applied is low, such that it can only barely be felt by the individual, while in other embodiments the pressure may be increased, including up to the point before there is any discomfort or pain. When there is pain or discomfort, body starts to resist and releases adrenaline and cortisol, which are detrimental to healing.

The muscles and/or tendons are fully shortened and fully relaxed as much as possible.

The techniques disclosed herein may be performed by an individual on himself, may be performed with the aid of another, or in some combination of these approaches. After performing the techniques of the invention over a period of time, an individual's body will have significantly improved flexibility, length, range of motion, suppleness and/or alignment. For example, the extended range of motion can be seen in increased range of motion during exercises such as “cats and dogs,” “windmill,” and standing twist. The inventors have even seen that a stooped individual will be able to stand more erect and will actually be taller as a result of the improved body alignment.

### EXAMPLES

The following examples are provided to show techniques of how to apply the concepts of the invention, of rubbing muscles and/or tendons in their shortened and relaxed state. As can be appreciated, the invention is not limited by these specific steps set forth below. Further, the specific regimen/steps can evolve over time. Of course, certain regimens may combine steps from both examples. Further, not all of the steps and regimens described below must be performed to obtain the advantages of the invention. The steps in the examples need not be performed in the order outlined, although, in certain embodiments, they may be.

### Example 1

### Longeuer (means lengthen in French) Method Performed on Yourself

Sit in a chair in front of a desk:
1. Squeeze eyebrows together and rub area between eye brows.
2. On the left side of face squeeze from the eye brow to upper forehead together and rub.
3. In the middle of face squeeze from between the eye brows and upper forehead together and rub.
4. On the right side of face squeeze from the eye brow to upper forehead together and rub.
5. Push the right cheek up toward the eye and rub above the cheek.
6. Push the left cheek up toward the eye and rub above the cheek.
7. Put the right hand over the head and move the head to the right side and use the left hand to rub the right side of the face from the ear to the middle of the mouth in three sections. Rub the right of the neck. Move the head forward and rub the front of the neck an under the chin. Move the head backward and rub the back of the neck.
8. Put the left hand over the head and move the head to left and use the right hand to hand to rub the right side of the face from the ear to the middle of the mouth in three sections. Rub the left side of the neck. Move the head forward and rub the front of the neck and under the chin.
9. Hold your right hand in front of you with your fingers curled and rub your fingers, thumb, palm of your hand and outside of the thumb.
10. Hold your left hand in front of you with your fingers curled and rub your fingers, thumb, palm of your hand and the outside of your thumb.
11. Place the tips of your right hand fingers on the edge of the desk and allow the hand to hang down. Rub the back of the hand.
12. Place the tips of your left hand fingers on the edge of the desk and allow the hand to hang down. Rub the back of the hand.
13. Place your right elbow on the desk with your forearm and hand pointing upward. Rub your forearm and wrist in three sections.
14. Place your left elbow on the desk with your forearm and hand pointing upward. Rub your forearm and wrist in three sections.
   Use a chair on which your arm is comfortably elevated when you are sitting:
1. Stand next to the chair and put your right arm on the top and sit down letting your arm become parallel to the ground. Rub the right shoulders and traps.
2. Stand next to the chair and put your left arm on the top and sit down letting your arm become parallel to the ground. Rub the left shoulders and traps.
3. Sit in the chair and bend over putting all your weight on the right leg. Then rub the left ankle.

Then lift the left leg with the heel lightly on the ground and use your right fingers to curl the left toes and rub the bottom of the left foot.
4. Sit in the chair and bend over putting all your weight on the left leg. Then rub the right ankle.

Then lift the right leg with the heel lightly on the ground and use your left fingers to curl the right toes and rub the bottom of the right foot.

Sit on the floor with your back against a chair, ottoman or the wall in a comfortable position with the legs essentially straight out in front of you:
1. Right leg
   a. Lift the leg so the knee is in the air and the angle behind the knee is about 90 degrees and the foot is resting on the heel and pointed down. Rub the back of the lower leg.
   b. With the leg essentially straight use the left leg to move the right foot back without twisting the right foot. Rub the lower right leg in the front from the ankle to the knee.
   c. Lower the right leg to where the knee feels the loosest and rub from below the knee to just above the knee.
   d. Keeping the right knee loose rub the upper leg.
2. Left leg
   a. Lift the leg so the knee is in the air and the angle behind the knee is about 90 degrees and the foot is resting on the heel and pointed down. Rub the back of the lower leg.
   b. With the leg essentially straight use the right leg to move the right foot back without twisting the right foot. Rub the lower left leg in the front from the ankle to the knee.
   c. Lower the left leg to where the knee feels the loosest and rub from below the knee to just above the knee.
   d. Keeping the left knee loose rub the upper leg.
      Lay on the floor face up with your legs over an ottoman or clothes basket, etc. with your lower legs at a 90 degree angle to the upper legs. Use pillows or blankets if necessary to achieve this angle. Also use a pillow to support your neck if necessary.
1. Use both hands to rub the area below your stomach and next to your legs.
2. Move your legs so they are out to the side comfortably and:
   a. Rub the outside of both legs.
   b. Rub the side of both hips.
   c. Move the legs so they are walking width apart and rub the back of the legs from below the knee to the glutes.
   d. Move the legs inside walking width one at a time and rub the inside of the leg from the knee to the hip.
      Lay on the right side with your upper body on a wedge, your head on a bolster with a pillow between your legs. After completing 1 thru 6 switch to the left side and do 1 thru 6 again on the left side.
1. Use your forearm to rub the area below the ribs and above the hips
2. Use your hand to rub areas on your back above your hips and then just above that.
3. Use your hand to rub your stomach from the up hip to the middle.
4. Use your hand to rub your chest from the up shoulder to the middle
5. Use your hand to rub the side of your up ribs.
6. Move the upper leg forward slightly and rub the inside in three or four sections.

### Example 2

### Longeuer Method Being Performed With the Assistance of Another Person

Lying prone (face down) on table and flat:
1. Feet in shorten position by curling toes back—rub soles and heels.
2. Lower leg @80 to 90 degrees to upper leg.
   a. And plantar flex the foot and rub the back of the lower leg.
   b. Rub hamstring up to glutes.
   c. Rub adductors.
   d. Rotate lower leg to outside and rub the outside of the upper leg and hip
3. Place bolster under legs just above the knees and externally rotate lower leg and rub the glutes and hips.
   Lying prone (face down) with upper body on wedge so back is in extension:
1. Start at tailbone and rub up lumbar area.
2. Rub up erectors.
3. Place blocks under shoulders.
   a. Put light pressure on shoulder blades to retract scapula towards spine and then rub shoulder blade area.
   b. Rub posterior shoulder to shoulder blade area.
   c. Neck is in extension so rub traps and base from skull.
   d. Rub scalp.
   e. Rub back of elbow to shoulder.
   f.
      Lying on side with upper body on wedge, head on another wedge, draping top arm forward and with a bolster between the knees:
1. Rub lats, senates, obliques and abdominals (from top of hip to back of shoulder).
2. Rub side and front of ribs to breast bone.
3. Rub top of shoulder to the ear (traps, scalenes) and along collar bone (arm is held in flexion).
4. Hold arm overhead and rub deltoids.
5. Rub abdominals.
6. Abduct flexed knee to rub outside of leg and hip.
7. With pillow between knees rub Sartorius of uppermost leg.
   Lying supine (face up) with legs propped at approximately 90 degrees:
1. Feet dorsi flexed and toes moved toward leg—rub top of feet and front of lower leg.
2. Move legs to outside and rub outside of upper legs and hips.
3. Move legs to inside and rub inside of upper leg.
4. With lower leg centered rub back of legs.
5. Rub above psoas using caution near genitals.
   Lying supine (face up) with upper body on wedge.
1. Adjust leg so knee and upper leg feel softest and rub the knee and upper leg.
2. Move heel toward knee and rub calf.
3. Rub rib and intercostal.
4. With wedges under shoulders rub pecs to sternum.
5. With fingers curled rub inside of the hand and side of thumb.
6. With fingers extended rub the back of hands.
7. Hold the lower arm at a ninety degree angle to the upper arm and rub arm and biceps.
8. Move head forward and rub front of neck.
9. Move head to each side and rub neck and head for that side.
10. Move head back and rub back of neck.
11. Move eye brow area and top of scalp together and rub forehead.
12. Move the cheeks toward the eyes and rub the area next to the eyes.

1. A system to improve body alignment of a individual comprising:
a. shortening and relaxing the individual's muscles and tendons; and
b. rubbing the shortened and relaxed muscles and tendons,
wherein steps a and b serve to relax and lengthen the muscles and tendons, which leads to an improvement in body alignment.

2. The method of claim 1 further comprising performing exercises after steps a and b.

3. The method of claim 1 wherein the muscles and tendons are in one area of the body.

4. The method of claim 1 wherein the muscles and tendons are in more than one area of the body.

5. The method of claim 1 wherein the muscles and tendons are shortened and relaxed by first flexing the muscle and then relaxing the muscle.

6. The method of claim 1 wherein the muscles and tendons are shortened by moving of the body part containing the muscles and tendons by another person.

7. The method of claim 1 as shown in examples 1 and 2.

8. A system to improve body alignment of a individual comprising a stretching method comprising:
a. shortening and relaxing the individual's muscles and tendons; and
b. applying pressure to the shortened and relaxed muscles and tendons; wherein regimens as shown in at least one of the examples 1-2 is performed.

9. The method of claim 7 further comprising performing exercises after steps a and b.
